(19) United States
(12) Patent Application Publication
(10) Pub. No.: US 2017/0110119 A1
(43) Pub. Date: Apr. 20, 2017

(54) ELECTRONIC INTERACTIVE CHANTING AND PRAYING SYSTEM DEVICE

(71) Applicant: MING-CHIEH HSU, Taoyuan (TW)

(72) Inventor: MING-CHIEH HSU, Taoyuan (TW)

(21) Appl. No.: 15/285,686

(22) Filed: Oct. 5, 2016

(30) Foreign Application Priority Data
Oct. 14, 2015 (TW) 104216463

(51) Int. Cl. G10L 15/08; A63J 5/02; F21S 9/02; F21V 33/00; H04R 1/02; H05B 37/02

(52) U.S. Cl. CPC G10L 15/08; H04R 1/028; H05B 37/0236; F21S 9/02; F21V 33/0004; A63J 5/025

(57) ABSTRACT

An electronic interactive chanting and praying system device includes a substrate, a voice input device installed to the substrate for receiving a voice message, a control processing device installed to the substrate and coupled to the voice input device for receiving the voice message and conducting a voice recognition processing to selectively generate a light source control instruction and a sound source control instruction, a light emitting device installed to the substrate and coupled to the control processing device for executing a light emitting mode according to the light source control instruction, and a speaker installed to the substrate and coupled to the control processing device for playing a piece of religious voice information according to the sound source control instruction.

### FIELD OF THE INVENTION

The present invention relates to a religious apparatus, in particular to an electronic interactive chanting and praying system device capable of generating a light source or a sound source in different modes according to the content of a user's name in religion or a Buddhist name, the number of times, or the sound volume of the chanting and praying.

### BACKGROUND OF THE INVENTION

1. Description of the Related Art

Most people have their own religious beliefs. Regardless of a traditional religious belief or a foreign religious thought, the religious belief is not just for praying for protection and peace, removing misfortune, and eliminating disaster for people, but also for seeking spiritual comfort and sustenance in unknown area and helpless future, so that religious belief is an indispensible spiritual activity to people.

Common religious activities of religious believers generally include worship or chanting taken place at home or in temples. Religious apparatuses such as Buddha statutes, Buddhist paintings or crosses are usually furnished at home, temples or temple fairs, so that the religious believers can worship God, recite scriptures, and pray to God while facing the religious apparatuses. However, the religious apparatuses of this sort are just a symbolic apparatus with no functions other than a decoration provided for people's worship and prayer.

2. Summary of the Invention

In view of the drawback of the prior art, it is a primary objective of the present invention to provide a religious apparatus, particularly an electronic interactive chanting and praying system device capable of producing a light source or a sound source of different modes according to the content of a user's name in religion, Buddhist name, or other religious terms, or the number of times or the sound volume of the prayer or chanting.

To achieve the aforementioned objective, the present invention discloses an electronic interactive chanting and praying system device, comprising: a substrate, having a pattern layer or being provided for placing a Buddha statue; a voice input device, installed to the substrate, for receiving a voice message; a control processing device, installed to the substrate and coupled to the voice input device for receiving a voice message and conducting a voice recognition processing to selectively generate a light source control instruction and a sound source control instruction; a light emitting device, installed to the substrate and coupled to the control processing device for executing a light emitting mode according to the light source control instruction; and a speaker, installed to the substrate and coupled to the control processing device for playing a piece of religious voice information according to the sound source control instruction.

Preferably, the electronic interactive chanting and praying system device further comprises a power supply device installed to the substrate and coupled to the voice input device, the control processing device, the light emitting device and the speaker.

Preferably, the power supply device includes a battery or a Mains plug.

Preferably, the control processing device generates a light source control instruction or a sound source control instruction according to the content of the recognized voice message.

Preferably, control processing device further generates a different light source control instruction or sound source control instruction according to the number of times, the sound volume or their combination of the received voice message.

Preferably, the light emitting device emits a light source with a specific brightness according to the received light source control instruction.

Preferably, the light emitting device includes a plurality of light emitting elements and the light emitting elements emit light with a specific quantity according to the received light source control instruction.

Preferably, the substrate includes a base and a coilable element, and the coilable element is coupled to the base and movably coiled to the base, and the coilable element is installed with a pattern layer and a light emitting device, and the base is installed with a voice input device, a control processing device, a speaker and a power supply device.

Preferably, the substrate is a rectangular member, a circular disc member, a Buddha statue member, or a religious totem member.

Preferably, the substrate includes a base and a frame, and the frame is installed onto the base, and the frame is installed with the pattern layer and the light emitting device, and the base is installed with the voice input device, the control processing device, the speaker and the power supply device.

Preferably, the substrate a base and a frame, and the frame is installed onto the base to form a containing space, and the containing space is provided for placing the Buddha statue, and the frame is installed with the light emitting device, and the base is installed with the voice input device, the control processing device, the speaker and the power supply device.

Preferably, the electronic interactive chanting and praying system device further comprises a dry ice eruption device installed to the substrate and coupled to the control processing device and power supply device.

Preferably, the pattern layer is a religious pattern and the voice message is a religious discourse.

Preferably, the pattern layer is disposed on the substrate by a sticking or printing method.

In summation, the electronic interactive chanting and praying system device of the present invention changes the original monotonous praying and chanting into lively and interesting, so as to promote the Buddha population and improve the fun and interest of religious believers' chanting and praying. Particularly, children who do not understand the actual meaning of chanting or praying may be attracted by the light and sound produced by the electronic interactive Buddhist apparatus and unconsciously fall into love with the prayer or name of Buddha, so as to start developing the chanting and praying habit from childhood.

### BRIEF DESCRIPTION OF THE DRAWINGS

FIG. 1 is a schematic view of an electronic interactive chanting and praying system device of a first preferred embodiment of the present invention;

FIG. 2 is a schematic view of an electronic interactive chanting and praying system device of a second preferred embodiment of the present invention;

FIG. 3 is a schematic view of a shrine of an electronic interactive chanting and praying system device of a third preferred embodiment of the present invention;

FIG. 4 is a schematic view of a strap of an electronic interactive chanting and praying system device of a fourth preferred embodiment of the present invention;

FIG. 5 is a schematic view of a rolling curtain of an electronic interactive chanting and praying system device of a fifth preferred embodiment of the present invention;

FIG. 6 is a schematic view of a God's instruction card of an electronic interactive chanting and praying system device of a sixth preferred embodiment of the present invention;

FIG. 7 is a schematic view of an ancestor card of an electronic interactive chanting and praying system device of a seventh preferred embodiment of the present invention;

FIG. 8 is a schematic view of a coffin of an electronic interactive chanting and praying system device of an eighth preferred embodiment of the present invention;

FIG. 9 is a schematic view of an electronic interactive chanting and praying system device of a ninth preferred embodiment of the present invention;

FIG. 10 is a schematic view of an electronic interactive chanting and praying system device of a tenth preferred embodiment of the present invention; and

FIG. 11 is a schematic view of an electronic interactive chanting and praying system device of an eleventh preferred embodiment of the present invention.

### DESCRIPTION OF THE PREFERRED EMBODIMENTS

The above and other objects, features and advantages of this disclosure will become apparent from the following detailed description taken with the accompanying drawings.

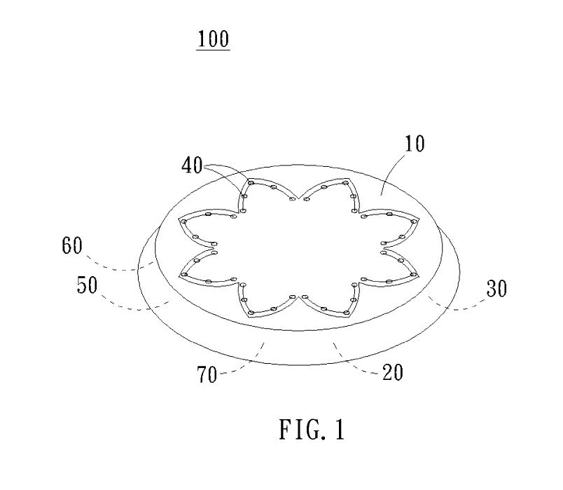

With reference to FIG. 1 for a schematic view of a schematic view of an electronic interactive chanting and praying system device in accordance with the first preferred embodiment of the present invention, the electronic interactive chanting and praying system device 100 comprises a substrate 10, a voice input device 20, a control processing device 30, a light emitting device 40, a speaker 50, a power supply device 60 and a dry ice eruption device 70, wherein the voice input device 20, the control processing device 30, the light emitting device 40, the speaker 50, the power supply device 60 and the dry ice eruption device 70 are installed to the substrate 10, and the control processing device 30 is coupled to voice input device 20, the light emitting device 40, the speaker 50, the power supply device 60 and the dry ice eruption device 70, and the power supply device 60 is coupled to the voice input device 20, the light emitting device 40, the speaker 50 and the dry ice eruption device 70.

The substrate 10 is in a rectangular shape, a circular disc shape, a Buddha statue shape, or a religious totem shape. In this preferred embodiment, the substrate 10 is substantially in a circular disc shape and a pattern layer 11 is formed on the external surface of the substrate 10, and the pattern layer 11 is disposed on the substrate 10 by a sticking or printing method, which may be in a planar or three-dimensional form, wherein the pattern layer 11 is designed as a religious pattern. In this preferred embodiment, the pattern layer 11 is in form of a lotus flower.

The voice input device 20 is provided for receiving a voice message inputted by a user, and the voice message is a religious discourse such as Amitabha, the Name of Jesus, etc. The user may also input a to divination related discourse.

The control processing device 30 is provided for receiving the voice message and conducting a voice recognition processing to selectively generate a light source control instruction and a sound source control instruction. Wherein, the control processing device 30 generates the light source control instruction or sound source control instruction according to the content of the identified voice message. For example, if the voice message recited by the user is “Amitabha”, the control processing device 30 will generate a light source control instruction, and if the voice message inputted by the user is a divination related discourse, the control processing device 30 will generate a sound source control instruction.

The light emitting device 40 is provided for emitting light with a light emitting mode according to the light source control instruction generated by the control processing device 30. Specifically, the control processing device generates 30 a different light source control instruction according to the number of times, the sound volume or their combination of the received voice message, so that the light emitting device 40 emits a light source with a specific brightness or emits a light source in the modes of blinking, blinking continuously, being lit partially, or being lit fully according to the received light source control instruction. For example, if a user recites the Name of Buddha or Jesus for a larger number of times, the brightness of the light source will become increasingly brighter, or the frequency of blinking will be more quickly. Wherein, if the light emitting device 40 emits a light source in the fully or partially lit mode, then the light emitting device will require a plurality of light emitting elements that emit light with a specific quantity according to the received light source control instruction. Wherein, the light emitting element is an LED lamp, a laser lamp, etc, and the light emitting elements may be arranged and configured to be corresponsive to the pattern layer 11, but the invention is not limited to such arrangement only.

The speaker 50 is provided for playing a piece of religious voice information, a scripture, or a fortune poetry according to the sound source control instruction. Specifically, the control processing device 30 generates a different sound source control instruction according to the number of times, the sound volume or their combination of voice message, so that the speaker 50 will issue a piece of corresponsive religious voice information according to the received sound source control instruction. For example, the louder the sound volume of the divination related discourse recited by the user or the larger the number of times of the divination related discourse recited by the user, the better the fortune poetry. If the control processing device 30 has determined the number of times of “Amitabha” recited by the user and the divination related discourse is recited, then a better fortune poetry will be obtained. In addition, the user may control the speaker 50 directly to play a note with a different brightness and joyful sound, or play a Buddha scripture or Buddha music, so as to achieve the effect of relaxing or educating people.

The power supply device 60 is provided for supplying electric power to the voice input device 20, the control processing device 30, the light emitting device 40, the speaker 50 and the dry ice eruption device 70. Wherein, the power supply device 60 is a battery, preferably a rechargeable battery, or the power supply device 60 is a Mains plug, but the present invention is not limited to the aforementioned arrangement only.

The dry ice eruption device 70 is controlled by the control processing device 30 for erupting dry ice, wherein the dry ice eruption device 70 may be turned on manually by the user or through a voice recognition method, and the operation of the light emitting device 40 and the speaker 50 can create the atmosphere of Buddha Light or the Coming of Buddha or Jesus Christ.

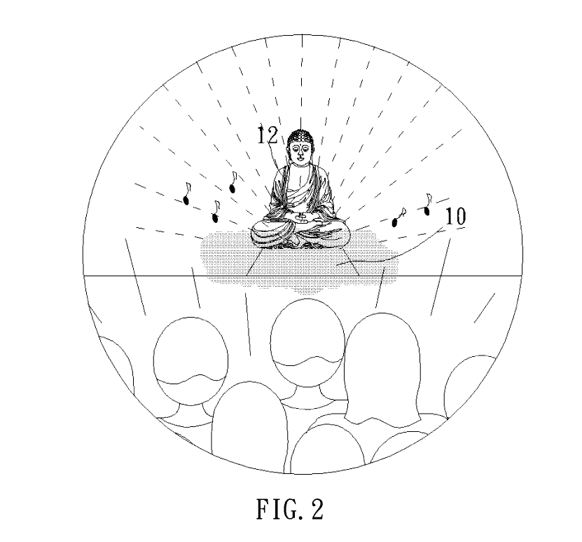

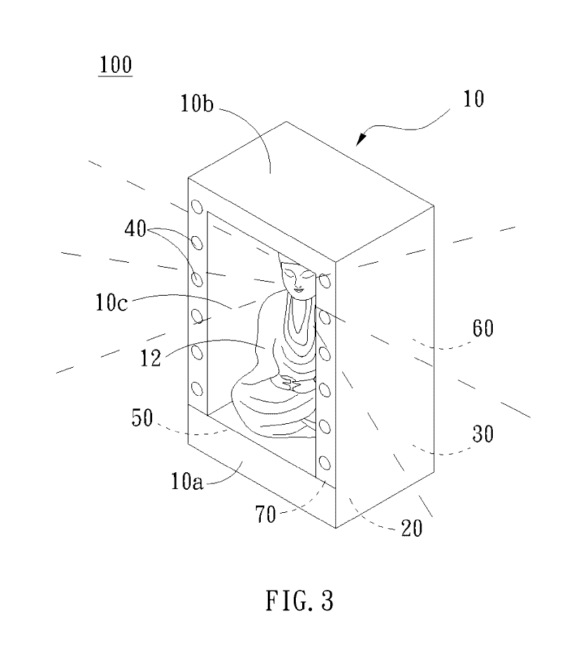

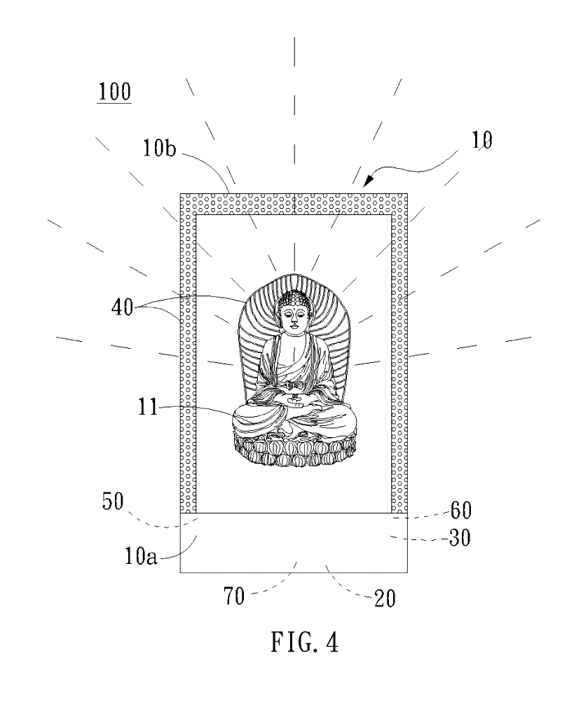

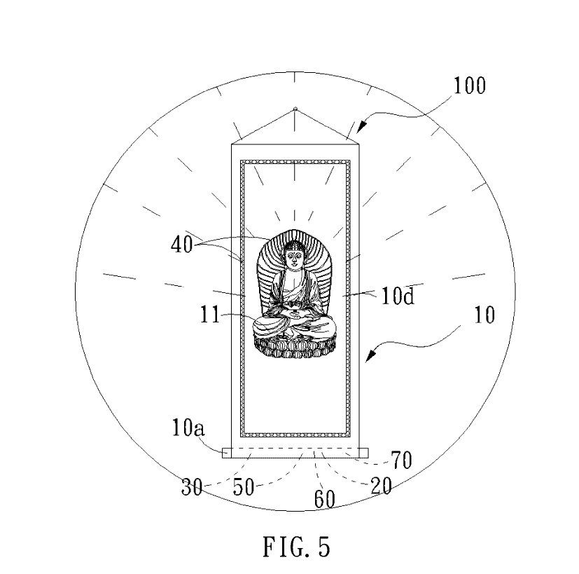

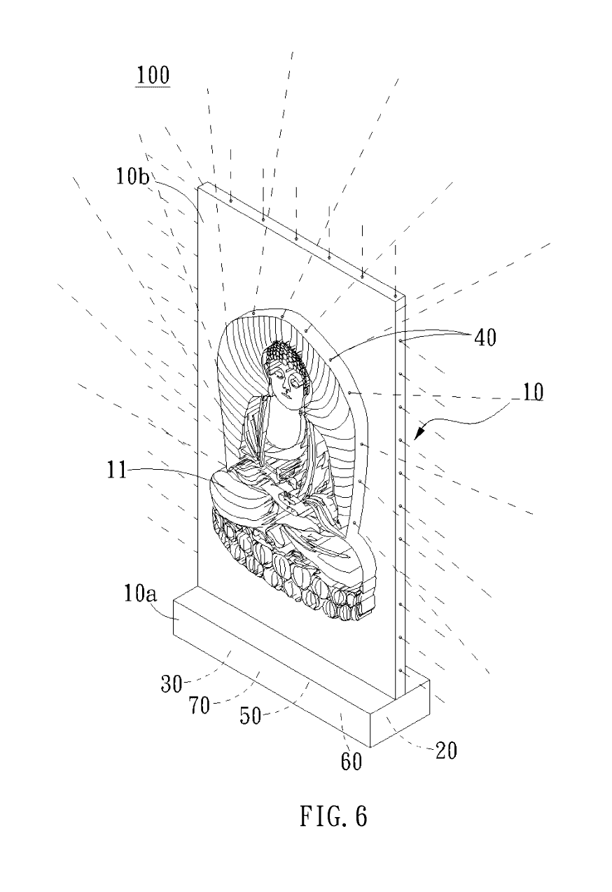

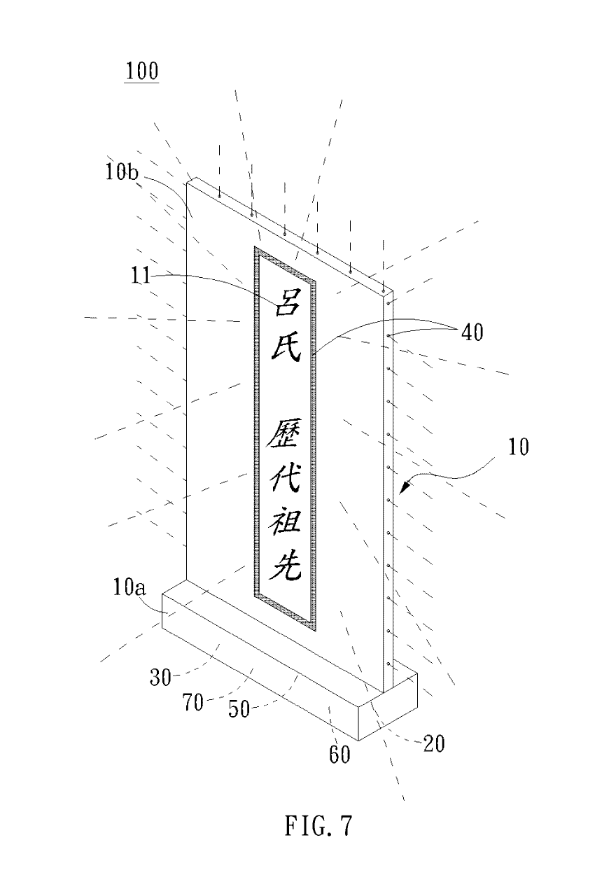

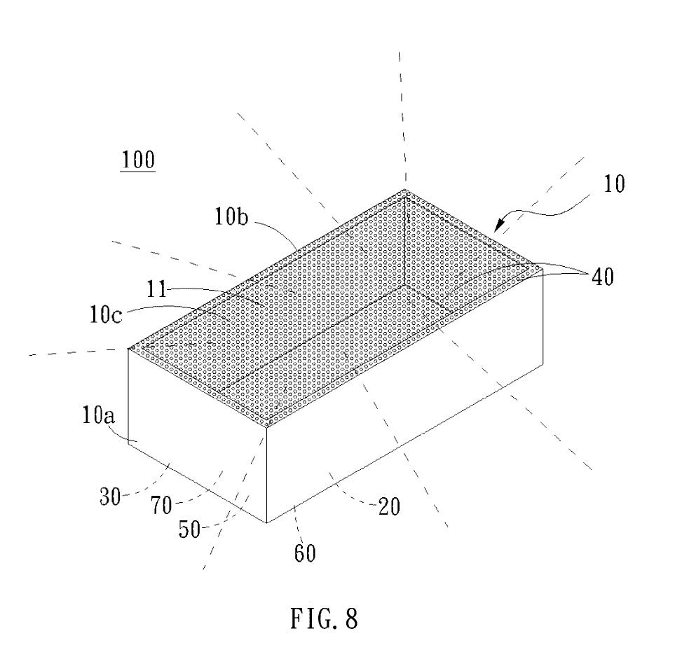

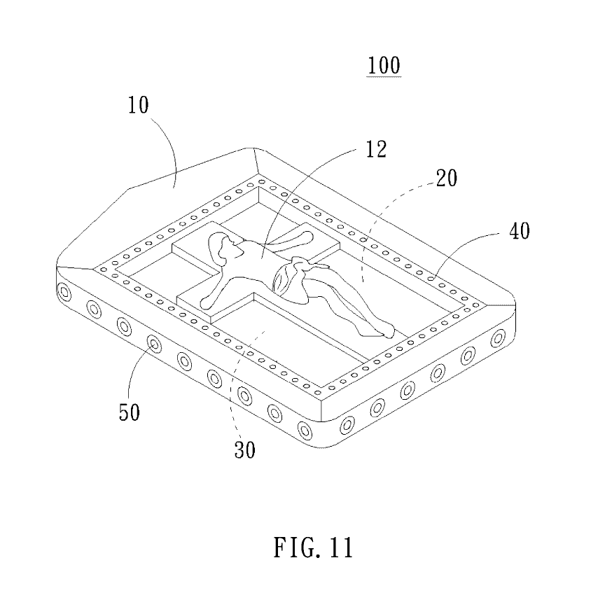

In summation of the description above, the substrate 10 may be installed with a pattern layer 11 or provided for installing a Buddha statue 12 as shown in FIG. 2, or the substrate 10 may be designed into another form. For example, the substrate 10 further includes a base 10a and a frame 10b, and the frame 10b is installed onto the base 10a to form a containing space 10c, and the containing space 10c is provided for placing the Buddha statue 12, and the frame 10b is installed to the light emitting device 40, and the base 10a is installed with a voice input device 20, a control processing device 30, a speaker 50, a power supply device 60 and a dry ice eruption device 70 as shown in FIG. 3, so as to constitute the form of a shrine or the form of a coffin as shown in FIG. 8. In FIGS. 4, 6, 7, 9 and 10, the substrate 10 includes a base 10a and a frame 10b, and the frame 10b is installed onto the base 10a, and the frame 10b is installed with the pattern layer 11 and the light emitting device 40, and the base 10a is installed with the voice input device 20, the control processing device 30, the speaker 50, the power supply device 60 and the dry ice eruption device 70 so as to form the shape of a strap, a God's instruction card or an ancestor card. In addition, the electronic interactive chanting and praying system device 100 may be manufactured into a form of a rolling curtain as shown in FIG. 5, and the substrate 10 includes a base 10a and a coilable element 10d, and the coilable element 10d is coupled to the base, and the coilable element 10d is movably coiled to the base 10a. The coilable element 10d is installed with the pattern layer 11 and the light emitting device 40, and the base 10a is installed with the voice input device 20, the control processing device 30, the speaker 50 and the power supply device 60. In FIG. 11, the substrate 10 is a casing, so as to form a pending or hanging strap, and the substrate 10 is provided for placing a Buddha statue member 12, and the Buddha statue member may be a three-dimensional body of an Eastern or Western worship statute (such as Sakyamuni Buddha, Amitabha, Guanyin, Mazu, Maitrey Buddha and Western Gods such as Jesus Christ, Saint Mary, Cross, etc.

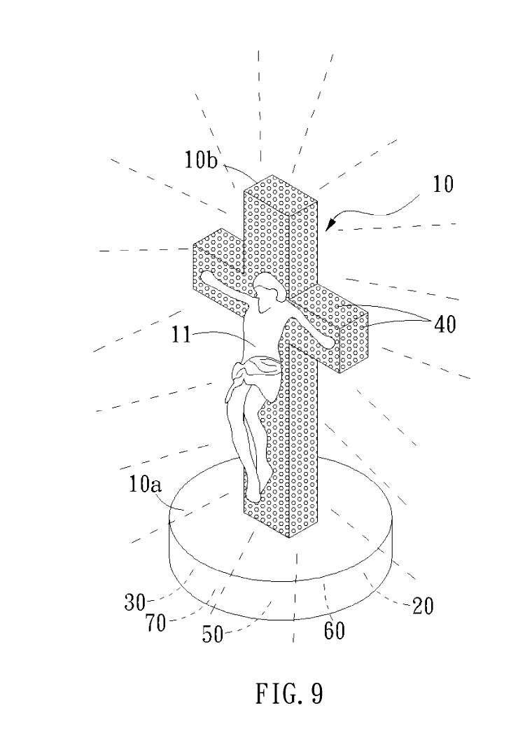

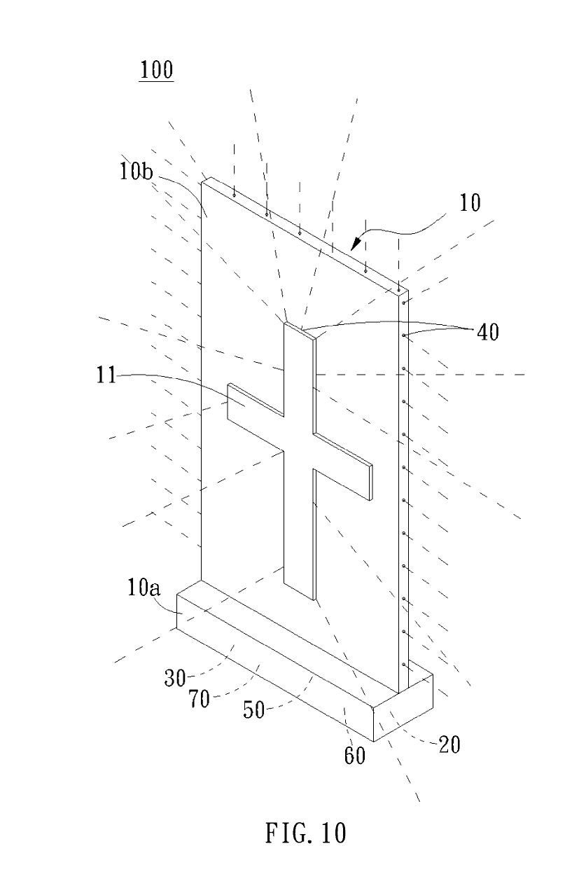

Of course, the substrate 10 may be in form of a Buddha statue, and such statute may be an Eastern or Western worship statute (such as Sakyamuni Buddha, Amitabha, Jesus Christ, Saint Mary, etc), or the substrate 10 may be in form of a Buddhist apparatus, a Taoist apparatus, or a cross (as shown in FIGS. 9-10).

In summation of the description above, the electronic interactive chanting and praying system device of the present invention primarily generates a light source and a sound source by a voice input recognition method or even produces a dry ice spray, so that a good interactive atmosphere is provided for the user's worship or chanting and helps the user can be more into the worship of the Gods.

What is claimed is:

1. An electronic interactive chanting and praying system device, comprising:
a substrate;
a voice input device, installed to the substrate, for receiving a voice message;
a control processing device, installed to the substrate, and coupled to the voice input device, and the control processing device receiving the voice message and conducting a voice recognition processing, and selectively generating a light source control instruction and a sound source control instruction;
a light emitting device, installed to the substrate, and coupled to the control processing device, for executing a corresponsive light emitting mode according to the light source control instruction; and
a speaker, installed to the substrate, and coupled to the control processing device, for playing a corresponsive piece of religious voice information according to the sound source control instruction.

2. The electronic interactive chanting and praying system device according to claim 1, further comprising a power supply device installed to the substrate and coupled the voice input device, the control processing device, the light emitting device and the speaker.

3. The electronic interactive chanting and praying system device according to claim 2, further comprising a dry ice eruption device installed to the substrate and coupled to the control processing device and the power supply device.

4. The electronic interactive chanting and praying system device according to claim 1, wherein the substrate has a pattern layer or provides a Buddha statue disposed thereon.

5. The electronic interactive chanting and praying system device according to claim 2, wherein the power supply device includes a battery or Mains plug.

6. The electronic interactive chanting and praying system device according to claim 5, further comprising a dry ice eruption device installed to the substrate and coupled to the control processing device and the power supply device.

7. The electronic interactive chanting and praying system device according to claim 2, wherein the control processing device generates the light source control instruction or the sound source control instruction corresponsive to the content of the recognized voice message.

8. The electronic interactive chanting and praying system device according to claim 5, wherein the control processing device generates the light source control instruction or the sound source control instruction according to the number of times, the sound volume or their combination of the received voice message.

9. The electronic interactive chanting and praying system device according to claim 7, wherein the light emitting device emits a light source with a specific brightness according to the received light source control instruction.

10. The electronic interactive chanting and praying system device according to claim 8, wherein the light emitting device includes a plurality of light emitting elements that emit light with a specific quantity according to the received light source control instruction.

11. The electronic interactive chanting and praying system device according to claim 2, wherein the substrate includes a base and a coilable element, and the coilable element is coupled to the base and movably coiled to the base, and the coilable element is installed with the pattern layer and the light emitting device, and the base is installed with the voice input device, the control processing device, the speaker, and the power supply device.

12. The electronic interactive chanting and praying system device according to claim 11, further comprising a dry ice eruption device installed to the substrate and coupled to the control processing device and the power supply device.

13. The electronic interactive chanting and praying system device according to claim 4, wherein the substrate is a rectangular member, a circular disc member, a Buddha statue member, or a religious totem member.

14. The electronic interactive chanting and praying system device according to claim 2, wherein the substrate includes a base and a frame, and the frame is installed onto the base, and the frame is installed with the pattern layer and the light emitting device, and the base is installed with the voice input device, the control processing device, the speaker and the power supply device.

15. The electronic interactive chanting and praying system device according to claim 14, further comprising a dry ice eruption device installed to the substrate and coupled to the control processing device and the power supply device.

16. The electronic interactive chanting and praying system device according to claim 2, wherein the substrate includes a base and a frame, and the frame is installed onto the base to form a containing space, and the containing space is provided for placing the Buddha statue, and the frame is installed with the light emitting device, and the base is installed with the voice input device, the control processing device, the speaker and the power supply device.

17. The electronic interactive chanting and praying system device according to claim 16, further comprising a dry ice eruption device installed to the substrate and coupled to the control processing device and power supply device.

18. The electronic interactive chanting and praying system device according to claim 1, wherein the pattern layer is a religious pattern, and the voice message is a religious discourse.

19. The electronic interactive chanting and praying system device according to claim 1, wherein the pattern layer is disposed on the substrate by an sticking or printing method.
